(19) United States
(12) Patent Application Publication
(10) Pub. No.: US 2008/0257422 A1
(43) Pub. Date: Oct. 23, 2008

(54) Electro-Hydraulic Control Device, Valve and Activating Electronics

(75) Inventors: Christian Fack, Lohr Am Main (DE); Alexander Meisselbach, Rieneck (DE); Karlheinz Panzer, Schwebheim (DE)

Correspondence Address: DARBY & DARBY P.C., P.O. BOX 770, Church Street Station, New York, NY, 10008-0770, US

(73) Assignee: Bosch Rexroth AG, Stuttgart (DE)

(21) Appl. No.: 12/097,709

(22) PCT Filed: Nov. 25, 2006
(86) PCT No.: PCT/EP2006/011322

§ 371 Date: Jun. 16, 2008

(30) Foreign Application Priority Data
Dec. 15, 2005 (DE) 10 2005 060 414.5

(51) Int. Cl. F15B 21/08; F15B 13/04; F16K 31/02

(52) U.S. Cl. 137/487.5; 91/361

(57) ABSTRACT

An electro-hydraulic control device is equipped with a valve and with activating electronics for the electrical activation of the valve as a function of a control signal. A sensor component or actuator component which is held on the valve, is connected to the activating electronics by means of an electrical connecting line. A non-volatile data memory is arranged on or in the sensor component or the actuator component, and the data of the data memory can be read out via the electrical connecting line.

### CROSS REFERENCE TO PRIOR APPLICATIONS

This application is a U.S. National Phase application under 35 U.S.C. § 371 of International Application No. PCT/EP2006/011322, filed on Nov. 25, 2006 and claims benefit to German Patent Application No. DE 10 2005 060 414.5, filed on Dec. 15, 2005. The International Application was published in German on Jul. 5, 2007 as WO 2007/073816 under PCT Article 21 (2).

The present invention relates to an electro-hydraulic control device. Moreover, the invention relates to a valve having at least one actuator component or sensor component as well as an electronic triggering unit for triggering such a valve.

### BACKGROUND

Directional valves, pressure valves or flow control valves that are used in electro-hydraulic control devices are moved by means of an actuation device that can be triggered electrically. An example of such a valve is a directly controlled proportional directional valve. With this type of valve, a force is exerted onto the valve stem by the armature of an electromagnet. This force can be adjusted by a control current that is applied to the electromagnet. The degree of opening results from the interaction of the armature with a spring that counters the movement of the valve stem. Such valves are generally known. A 4/2 proportional directional valve is shown, for example, in Data Sheet RD 29047/09.05 of the Bosch Rexroth company.

An electronic triggering unit is used to trigger the actuation device. As a function of a prescribed signal, this unit generates a control current for an electromagnet of the valve. At the present time, various electronic triggering units are used for different types of valves. However, the mechanical behavior of the valves differs not only among individual types of valves, but also among individual valves of the same type. This is due, among other things, to manufacturing tolerances. For instance, the valve control edges (and thus the covering length) can vary slightly from one valve to another. In order to minimize the series tolerances of the system consisting of the valve mechanism, the actuation device and the electronic triggering unit, the control parameters of the electronic triggering unit are determined individually for each valve on the basis of its characteristic curve and adjusted by means of suitable adjustment elements of the electronic triggering unit. This achieves an optimized control behavior that is virtually identical for all valves of the same type.

A feedback loop, for example, of the control slide position to the electronic triggering unit, creates a closed-loop control system. The control behavior of the system consisting of the valve, the electronic triggering unit and the actuation device is determined by the controller types and the control parameters. There is a wide selection of controller types that determine the control behavior. In the description below, no consistent distinction will be made between regulation and control. The term control is also meant to allow a possible expansion to include a closed-loop control system.

The electronic triggering unit can be arranged separately from the valve or else can be mounted on the valve. The latter case is referred to as an OBE configuration (on-board electronics). Since the electronic triggering unit is adapted to and mounted on the valve by the manufacturer, such valves can be used without any further configuration work or they can be replaced by a valve of the same type.

A drawback of the conventional concept of an electro-hydraulic control device is that many different electronic triggering units have to be made available as a function of the different types of valves. These electronic triggering units, which are often only used in small numbers, entail a huge effort in terms of logistics as well as in terms of development and production. In order to achieve a reproducible control or regulation behavior of the electro-hydraulic control device, the electronic triggering unit has to be adjusted to a prescribed characteristic curve on the basis of a measurement of the characteristic curve of the valve prior to the first time of operation or in case of a replacement of the electronic triggering unit. This makes the assembly and start-up, the maintenance and the repairs of electro-hydraulic systems more difficult. OBE valves with a pre-configured electronic triggering unit that is preassembled on the valve can be used immediately, but, in case of a defect in the electronic triggering unit, they are extremely labor-intensive to repair. Any newly installed electronic triggering unit would have to be adjusted before being started up by measuring the characteristic curve of the valve once again. This is why, as a rule, the entire valve is replaced when it needs servicing.

### SUMMARY OF THE INVENTION

An object of the present invention is to provide an improved electro-hydraulic control device or valve and an electronic triggering unit that may simplify the adjustment of an electronic triggering unit to an individual valve.

The present invention provides an electro-hydraulic control device and also a valve and an electronic triggering unit relating to an electro-hydraulic control device.

The electro-hydraulic control device according to one aspect of the invention is equipped with a valve and with an electronic triggering unit for electrically triggering the valve as a function of a control signal. A sensor component or actuator component affixed on the valve is connected to the electronic triggering unit via an electric connecting line.

A feature of the present invention is that a non-volatile memory is arranged on or in the sensor component or actuator component, and that the data of the memory can be read out via the electric connecting line. In this manner, data pertaining to the optimal triggering of each individual valve can be stored non-erasably on the valve. The stored data facilitates the configuration of an electronic triggering unit during assembly, start-up and maintenance. The arrangement of the memory in or on a sensor component such as, for instance, an inductive displacement pick-up or an actuator component such as, for example, an actuation magnet, is a very cost-effective solution. The sensor component or the actuator component can be produced together with the memory as a preassembled modular unit and affixed to the valve housing in one work step. The valve housing can also be manufactured by means of purely mechanical processing. In any case, the sensor component or actuator component comprises an electrical connection to the electronic triggering unit. According to the invention, this existing interface can be used for reliable, hard-wired communication with the memory. This eliminates the need for extra expenditures for additional connections or for additional transmission modalities for the data. The conventional, cost-optimized design of the valve and of the sensor component or actuator component can be retained.

Additional advantageous embodiments are put forward in the dependent claims.

In a preferred embodiment of the present invention, the electronic triggering unit can be configured on the basis of the read-out data. This allows a simple and efficient configuration and adaptation of an electronic triggering unit to an individual valve. In particular, the configuration can be made automatically, for example, when the electric connection is established between the electronic triggering unit and the sensor component or actuator component, or else every time the electronic triggering unit is switched on. Thus, the valve is ready for operation shortly after the electronic triggering unit has been connected to the electric components of the valve. There is no need for a complicated manual configuration or a calibration of the characteristic curve of the valve with respect to a prescribed characteristic curve after the installation of the electronic triggering unit. If an electronic triggering unit mounted on the valve is being used, it can be simply replaced. Moreover, on the basis of the data stored in the memory, the configuration of the electronic triggering unit allows the use of an electronic triggering unit that can be employed for many different types of valves and that adapts itself, on the one hand, to the particular type of valve and, on the other hand, to the individual valve properties on the basis of the data that can be requested at the valve or at the actuation device.

Preferably, the memory is arranged inside a housing of the sensor component or actuator component. As a result, the data storage unit is protected against environmental influences. A suitable place for arranging the memory is, for example, a receptacle formed by the housing. The memory can be easily assembled if it is arranged in a housing of a connector or of a connecting socket of the sensor component or actuator component.

If a communication device, for example, a transmitting device or a receiving device, is arranged on the side of the sensor component or actuator component and on the side of the electronic triggering unit, for purposes of a serial transmission of data via the connecting line, a robust transmission of the data of the memory is achieved via two conductors of the electric connection between the sensor component or actuator component and the electronic triggering unit.

If a type designation of the valve is stored in the memory, the electronic triggering unit can be configured according to a circuit structure or controller structure associated with that type of valve. Preferably, however, an identifier that defines a circuit structure or controller structure of the electronic triggering unit can be stored in the memory. Thus, valves that call for a different controller structure can be triggered with an electronic triggering unit of the same design.

Preferably, one or more parameters that define the control or regulation behavior of a given type of valve are stored in the memory. These parameters determine the behavior of individual components of the control or regulation circuit of the electronic triggering unit. These parameters are, for example, amplification factors or the P, I and D components of a PID controller. As a result, first of all, a basic tuning of the electronic triggering unit can be carried out in order to adapt it to the type of valve in question. Moreover, the parameters can undergo fine tuning in order to adapt the characteristic curve of the valve to a setpoint characteristic curve of the valve. For this purpose, for example, parameters that relate to the covering length or the maximum deflection of the valve stem can be adjusted individually on the basis of a measurement of the characteristic curve of the valve. Furthermore, tolerance-related deviations of the characteristic curve of the valve from the setpoint characteristic curve of the valve can be stored in the memory. Owing to these measures, a fine tuning is carried out in order to achieve optimal valve behavior.

Since most electrically actuatable valves are equipped with an actuation magnet, it is quite convenient for the memory to be arranged on a component of the actuation magnet. Then the connecting line between the electronic triggering unit and the actuation magnet, which carries the actuation current, can be used to transmit the data of the memory. This makes it possible to retain the conventional design of the plug-in connector. Moreover, the principle of the storage of configuration data on the valve can thus be used universally for almost all electrically actuatable valves. If the memory is arranged on a coil insulating frame of the magnet coil, it can easily be mounted together with the coil insulating frame. Preferably, on the basis of the carrier frequency or voltage used for the transmission, data transmitted on the connecting line can be distinguished from the actuation current. As a result, the data can be transmitted independently of the actuation current. The data transmission is preferably carried out at a point in time when the magnet is not being actuated, for example, during an initialization phase. This simplifies the structure of a communication device for reading out the memory.

If the valve is equipped with a displacement sensor, as an alternative, the memory can be arranged on the displacement sensor, that is to say, on a component of the displacement sensor. The data is then read out via the connecting line between the displacement sensor and the electronic triggering unit. If this is an inductive displacement sensor, it is practical for it to be arranged on a coil insulating frame of the displacement sensor. This minimizes the assembly effort needed for the memory. The memory is also well-protected against environmental influences. Since the triggering signal of a displacement sensor and its output signal can be kept within a very narrow band, it is quite convenient for the data of the memory to be transmitted on the same conductors of the connecting line that also carry the signals of the displacement sensor. For this purpose, on the basis of the carrier frequency or voltage used for the transmission, the data transmitted on the connecting line can preferably be distinguished from an triggering signal and/or an output signal of the displacement sensor. The differentiation of the data from the signal of the displacement sensor is advantageously made by means of suitable filters. The transmission on the connecting lines of the displacement sensor also offers the advantage of a good signal quality since the connecting line is shielded as a standard feature. Moreover, it is also practical here to carry out the data transmission at a point in time when no excitation of the displacement sensor is taking place, for example, during an initialization phase. This simplifies the structure of a communication device for reading out the memory. Moreover, a distortion of the response signal of the displacement sensor is avoided if no data is being transmitted while the sensor is being read out.

Particularly with valves having an OBE configuration, as an alternative, it is also possible to augment the connecting line of the displacement sensor or of the actuation magnet with a connecting line that serves exclusively for data transmission. This minimizes the effort for the data transmission, especially when no external connector of the valve or of the electronic triggering unit has to be modified with a great deal of effort.

### BRIEF DESCRIPTION OF THE DRAWINGS

The present invention and its advantages are explained in greater depth below with reference to the embodiment shown in the individual figures.

FIG. 1 shows a proportional directional valve having an actuation device and an electronic triggering unit connected thereto, as a component of an electro-hydraulic control device,

FIG. 2 shows a directional control valve with an actuation device, a displacement sensor and an electronic regulating unit attached to the valve, as a component of an electro-hydraulic control device.

### DETAILED DESCRIPTION

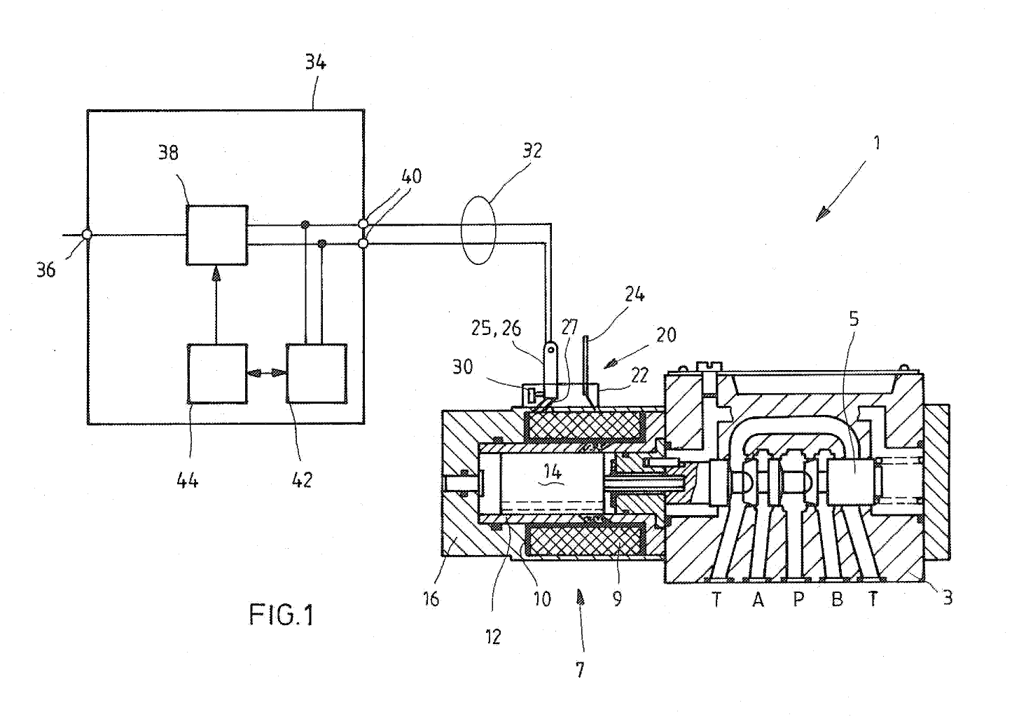

According to FIG. 1, a proportional directional valve 1 has a valve housing 3 and a valve stem 5 that is movably held in the valve housing 3. Together, the valve housing 3 and the valve stem 5 form a valve body. An electrically triggerable actuation device 7 is attached to the valve housing 3. The actuation device 7 consists essentially of a magnet coil 9 that is wound up on a coil insulating frame 10, a pole tube 12 over which the coil insulating frame 10 is slid, and an armature 14 that is movably mounted in the pole tube 12. The force exerted on the armature is transmitted to the valve stem 5 by means of an actuation pin installed on the armature 14. A housing 16 of the actuation device 7 accommodates the magnet coil 9 along with the coil insulating frame 10, the pole tube 12 and the armature 14.

A connector 20 is attached to the housing 16. The connector 20 has a housing 22 and three terminal pins 24, 25 and 26 connected thereto. In the view shown in FIG. 1, the terminal pins 25 and 26 are situated one directly behind the other. The housing 22 of the connector 20 is firmly connected to the housing 16 of the actuation device 7. The terminal pin 24 serves as a ground connection. The terminal pins 25 and 26 are each connected via a cable 27 to the magnet coil 9.

An electronic memory chip 30 is arranged inside the housing 22 of the connector 20. The memory chip 30 is electrically connected to the terminal pins 25 and 26. The memory chip is cast inside the connector 20, together with the terminal pins 24, and 26, in order to mechanically affix them and to protect them from environmental influences.

The actuation device 7 is connected to an electronic triggering unit 34 via a 2-conductor connecting line 32. The electronic triggering unit 34 has an input 36 where it receives a setpoint for an actuation of the valve 1. The input signal is supplied to a control circuit 38 for triggering the valve. The control circuit 38 generates a control current for actuating the magnet coil 9. This control current is supplied to the magnet coil 9 via two output connections 40 and via the connecting line 32. Moreover, the electronic triggering unit 34 is equipped with a communication circuit 42. The communication circuit 42 is connected to the output connections 40. The communication circuit 42 is connected to a configuration setting device 44. The configuration setting device 44 can set the circuit structure and the regulating parameters or control parameters of the control circuit 38.

The communication circuit 42 establishes access to the data of the memory chip 30 via the connecting line 32. For this purpose, the memory chip 30 is advantageously equipped with its own communication interface. Thus, making use of the connecting line 32, a serial data transmission can take place between the communication interface of the memory chip 30 and the communication circuit 42. Of course, as an alternative, the communication interface for the memory chip 30 can be configured as an autonomous electronic module.

Below, the function of the valve 1 and of the electronic triggering unit 34 will be described, especially in terms of the configuration of the electronic triggering unit 34. When a certain event occurs, for example, when the power supply of the electronic triggering unit 34 is switched on, when a connecting line is plugged into the connector 20, or when a reset switch is actuated, the communication circuit 42 establishes a data connection with the memory chip 30.

The data stored in the memory chip 30 is transmitted to the configuration setting device 44. The data represents parameters and identifiers on the basis of which the control circuit 38 is configured. The switching structure of the control circuit 38 can be specified on the basis of an identifier for a control or regulation structure. This relates, for example, to the arrangement of regulation or control members within a signal chain from the input 36 to the output 46 of the control circuit 38 and it also relates to the type of regulation and control members. Moreover, amplification factors—that is to say, the weighting of the individual regulation and control members—and the control and regulation behavior of individual members can be set by means of parameters that are read out of the memory chip 30.

The configuration set for the control circuit 38 or the configuration data read out of the memory chip 30 is stored in the electronic triggering unit 34 in a non-volatile memory. The electronic triggering unit 34 is thus adapted to the valve 1 automatically, efficiently and with little expenditure of time.

In order to specify the configuration data in the memory chip 30, the desired control and regulation structure is selected and an identification number that identifies the selected control or regulation structure is stored in the memory chip 30. On the basis of the identification number, the configuration setting device 44 later specifies the control or regulation structure of the control circuit 38. As an alternative, data that describes the set-up and the individual components (for example, regulation members) of the control or regulation structure can also be stored in the memory chip 30.

Moreover, as mentioned above, control or regulation parameters are stored in the memory chip 30. These parameters allow the precise adaptation of the characteristic curve of the valve to a prescribed characteristic curve. Subsequent to the production, a characteristic test curve is created for each valve by means of a calibrated electronic triggering unit. For this purpose, first of all, control or regulation parameters that are specific to the type of valve in question are used. On the basis of this characteristic test curve, certain control or regulation parameters are corrected individually for each valve within the scope of a fine tuning in order to match a prescribed characteristic curve. The control or regulation parameters are finally stored in the memory chip 30.

When the electronic triggering unit 34 is switched on, it is in an initialization mode at first. In the initialization mode, the electronic triggering unit 34 requests the configuration data that is stored in the memory chip 30. For this purpose, the communication circuit 42 establishes a connection with the memory chip 30 and reads out the configuration data. After the configuration data has been received, it is transferred from the communication circuit 42 to the configuration setting device 44, which configures the control circuit 38. Then the valve and its electronic triggering unit are ready for operation. This procedure can be carried out within a very short period of time, so that the user does not notice any considerable delay when the electro-hydraulic control device is switched on.

By storing the configuration data in the memory chip 30 that is arranged on or in the actuation device 7, this data remains linked to the valve in a manner that is readily accessible during the service life of the valve. Thus, a simple and quick configuration of the electronic triggering unit 34 is ensured during the start-up or in case of a repair. Moreover, only one generally usable type of electronic triggering unit 34 has to be developed, produced and kept in stock. The control or regulation structure of the electronic triggering unit is set automatically as a function of the configuration data stored in the memory chip. Moreover, there is no need for a complicated manual adjustment of the characteristic curve of the valve.

In the embodiment described above, the memory chip 30 is arranged inside the connector 20. By the same token, the memory chip 30 could also be located on the coil insulating frame 10 of the magnetic coil 9, or elsewhere in the interior of the housing 16 of the actuation device. For example, the housing 16 can have a recess in which the memory chip 30 is attached, preferably cast. It merely has to be ensured that the memory chip is electrically connected to the connecting line 32, that is to say, to the terminal pins 25 and 26.

The control circuit 38, the configuration setting device 44 and, if applicable, the communication circuit 42 are preferably realized in the form of a microcontroller and software installed in it. In this manner, by requesting certain components from a regulator function or control function library, all kinds of different control and regulation structures can be provided in the way they are specified by the data stored in the memory chip 30.

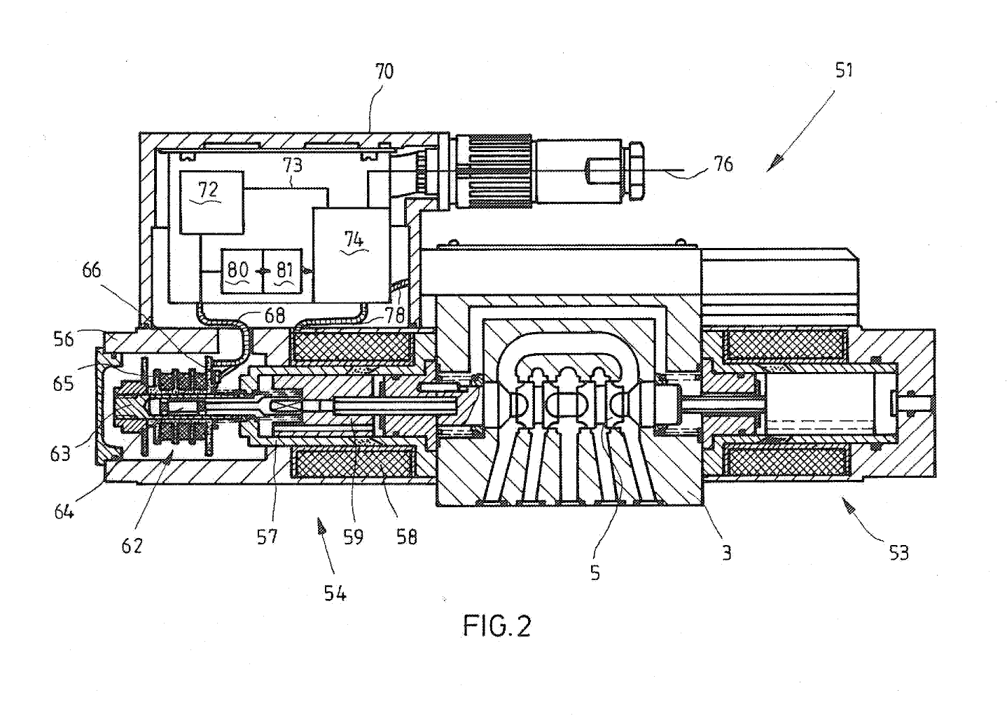

FIG. 2 shows another embodiment of the present invention making reference to a directional valve 51 having a valve housing 3 and a valve stem 5 similar to the embodiment shown in FIG. 1. Two actuation devices 53 and 54 are attached to the housing 3 of the valve 51. The housing 56 of the actuation device 54 additionally holds an inductive displacement sensor 62.

The actuation device 54 is essentially made up of an actuation magnet comprising a pole tube 57, a magnet coil 58 and an armature 59 movably mounted in the pole tube 57. The displacement sensor 62 is formed in the usual manner by a sensor tube 63 that is adjacent to the pole tube 57, by a ferromagnetic core 64 that is movably arranged in the sensor tube 63 and by a sensor coil 65 that is slid over the sensor tube 63. The ferromagnetic core 64 is coupled to a pin via which the armature 59 acts upon the valve stem 5. The sensor coil 65 comprises an excitation coil in the middle of its coil insulating frame and two measuring coils at the outer ends of the coil insulating frame. The excitation coil and the measuring coils are connected to an electronic triggering unit 70 of the valve 51 via a connecting line 68 consisting of at least four separate conductors.

A memory chip 66 is affixed to a coil insulating frame of the sensor coil 65. The memory chip 66 is electrically connected to the connecting line 68.

The electronic triggering unit 70 is attached to the housing 56. An evaluation circuit 72 generates the excitation signal for the excitation coil of the sensor coil 65 and evaluates the response signal of the measuring coils. The evaluation circuit 72 feeds the position value of the valve stem 5 as an actual-value signal 73 to the regulation circuit 74. As a function of a setpoint input 76 and of the measured actual-value signal 73, the regulation circuit 74 triggers the magnet coils of the actuation devices 53 and 54 via appropriate connecting lines 78.

The electronic triggering unit 70 also has a communication circuit 80 that is connected to the memory chip 66 via the connecting line 68. Moreover, a configuration setting device 81 is present that configures the regulation circuit 74 on the basis of the data read out of the memory chip 66.

In the valve 51, the sequence of the configuration of the regulation circuit 74 corresponds to the sequence of the configuration of the control circuit 38 on the valve 1. Therefore, the sequence of the configuration will not be described again here.

The difference between the valve 51 and the valve 1 lies essentially in the arrangement of the memory chip 66. Since the memory chip 66 is attached to the coil insulating frame of the sensor coil 65, a simple assembly of the memory chip 66 is ensured. Moreover, the normally shielded connecting line 68 of the displacement sensor 62 can be used for the transmission of data between the memory chip 66 and the electronic triggering unit 70. Since the evaluation of the sensor signal of the inductive displacement sensor 62 is based on a comparison of amplitudes, the frequency of the excitation signal of the displacement sensor can be limited. The data of the memory chip 66 can be transmitted on another free frequency via the connecting line 68. For this purpose, for example, a pair of conductors is used that connects one of the coils 65 to the evaluation circuit 72. A filter is used to prevent data transmitted by the memory chip 66 from distorting the read-out signal of the displacement sensor.

In the case of an electronic triggering unit 70 mounted on the valve housing 56, however, the connecting line 68 can also be easily expanded by additional conductors that serve exclusively for the data transmission to and from the memory chip 66. It is even possible to provide a dedicated connecting line between the memory chip 66 and the communication circuit 80. This simplifies the structure of the communication circuit 80 and of a communication circuit that can optionally be integrated into the memory chip. The additional material expenditure is slight since with such an OBE configuration, the connecting lines are connected to the electronic triggering unit 70 via simple board connectors.

When the person skilled in the art selects the displacement sensor, he/she is, of course, not limited to the above-described inductive displacement sensor. He/She selects the sensor that appears to be suitable from among the many displacement sensors known for the measurement of the position of the valve stem 5. The installation of a memory chip on a component of the displacement sensor is possible for all types of sensors because of the small dimensions of the conventional memory chips.

1-18. (canceled)

19. An electro-hydraulic control device, comprising:
a valve;
an electronic triggering unit configured to electronically trigger the valve as a function of a control signal,
an electric connecting line;
at least one of a sensor component and an actuator component affixed on the valve and connected to the electronic triggering unit using the electric connecting line;
a non-volatile memory chip arranged on the at least one of the sensor component and actuator component; and,
a data in the memory chip is readable using the electric connecting line.

20. The electro-hydraulic control device as recited in claim 19, wherein the electronic triggering unit is configurable according to the data.

21. The electro-hydraulic control device as recited in claim 19, further comprising a housing and wherein the memory chip is disposed in the housing.

22. The electro-hydraulic control device as recited in claim 21, wherein the memory chip is disposed in a recess of the housing.

23. The electro-hydraulic control device as recited in claim 19, further comprising a connector associated with the at least one of the sensor component and the actuator component and wherein the memory chip is disposed in the connector.

24. The electro-hydraulic control device as recited in claim 19, further comprising a communication circuit capable of a serial transmission of the data using the electric connecting line and wherein the communication circuit is disposed on a side of at least one of the sensor component and the actuator component and on a side of the electronic triggering unit.

25. The electro-hydraulic control device as recited in claim 19, wherein a type designation is stored in the memory chip.

26. The electro-hydraulic control device as recited in claim 19, wherein an identifier defining a circuit structure of the electronic triggering unit is stored in the memory chip.

27. The electro-hydraulic control device as recited in claim 19, wherein a parameter defining a control or a regulation behavior of the electronic triggering unit is stored in the memory chip.

28. The electro-hydraulic control device as recited in claim 19, wherein the at least one of the sensor component and the actuator component includes an actuation device having a magnet coil and an armature movably mounted in a pole tube.

29. The electro-hydraulic control device as recited in claim 28, wherein the memory chip is disposed on the magnet coil.

30. The electro-hydraulic control device as recited in claim 28, wherein the memory chip is disposed on the armature.

31. The electro-hydraulic control device as recited in claim 28, wherein the memory chip is disposed on the pole tube.

32. The electro-hydraulic control device as recited in claim 28, wherein the actuator device further includes a coil insulating frame of the magnetic coil, and the memory chip is disposed on the coil insulating frame.

33. The electro-hydraulic control device as recited in claim 28, wherein the magnetic coil is supplied with an actuation current and wherein the data is distinguishable from the actuation current according to a respective carrier frequency or voltage used for transmission of the data.

34. The electro-hydraulic control device as recited in claim 19, wherein the at least one of the sensor component and the actuator component includes a displacement sensor.

35. The electro-hydraulic control device as recited in claim 34, wherein the displacement sensor includes an inductive displacement sensor having a coil insulating frame and wherein the memory chip is disposed on the coil insulating frame.

36. The electro-hydraulic control device as recited in claim 34, wherein the displacement sensor is configured to generate at least one of a trigger signal and an output signal and wherein the data is distinguishable from the at least one of the trigger signal and the output signal according to a respective carrier frequency or voltage used for transmission of the data.

37. A valve device comprising
at least one of a sensor component and an actuator component;
an electronic triggering unit;
a connection configured to connect the at least one of the sensor component and the actuator component to an electronic triggering unit;
a non-volatile memory chip disposed on or in the at least one of the sensor component and the actuator component, and including a data; and,
wherein the data is readable out via the connection.

38. An electronic triggering device for triggering a valve comprising:
a connection configured to connect the electronic triggering device to at least one of a sensor component and an actuator component of the valve; and,
a communication device, configured to receive data from a memory.

39. The electronic triggering device as recited in claim 38, wherein a control or a behavior of the electronic triggering device is configurable according to the received data.
